(19) United States
(12) Patent Application Publication
(10) Pub. No.: US 2025/0237800 A1
(43) Pub. Date: Jul. 24, 2025

(54) OPTICAL MEMBER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Hiroshi ANDO, Nisshin-shi (JP); Masatoshi TSUJI, Nisshin-shi (JP); Masaaki KAWAUCHI, Nisshin-shi (JP)

(21) Appl. No.: 18/981,847

(22) Filed: Dec. 16, 2024

(30) Foreign Application Priority Data
Jan. 19, 2024 (JP) 2024-006713

(51) Int. Cl. F21V 8/00; G02B 27/00

(52) U.S. Cl. CPC G02B 6/0016; G02B 27/0018

(57) ABSTRACT

An optical member includes a light-transmitting light guide body and a light-shielding back cover. The light guide body has an incident part including a plurality of protruding incident prism portions, a reflective surface adjacent to the incident part, and an exit surface facing the incident part and the reflective surface. Each of the plurality of incident prism portions has an incident surface that allows an external scenery light to enter the inside of the light guide body and an adjacent surface adjacent to the incident surface. The back cover covers at least an entire area of the reflective surface of the light guide body across a gap, and abuts against the adjacent surface of a rear prism portion that is one of the plurality of incident prism portions adjacent to the reflective surface.

### CROSS REFERENCE TO RELATED APPLICATION

The present application claims the benefit of priority from Japanese Patent Application No. 2024-006713 filed on Jan. 19, 2024. The entire disclosures of the above application are incorporated herein by reference.

### TECHNICAL FIELD

The present disclosure relates to an optical member including a light guide body that allows a part of incident light entering from an incident surface to reflect therein and exits the incident light and the reflected light to the outside from a surface different from the incident surface.

### BACKGROUND

Conventionally, this type of optical member has been, for example, attached to a light shielding body, and is used as a blind spot auxiliary device that allows an external scenery light from a blind spot area caused by the light shielding body to enter the inside from an incident surface, reflects the external scenery light in the inside, and exits the external scenery light from a surface that is different from the incident surface, thereby causing the blind spot area to be viewed by a user.

### SUMMARY

The present disclosure describes an optical member. According to an aspect, the optical member includes a light-transmitting light guide body and a light-shielding back cover. The light guide body has an incident part including a plurality of protruding incident prism portions, a reflective surface adjacent to the incident part, and an exit surface facing the incident part and the reflective surface. Each of the plurality of incident prism portions has an incident surface that allows an external scenery light to enter the inside of the light guide body and an adjacent surface adjacent to the incident surface. The back cover covers at least an entire area of the reflective surface of the light guide body across a gap, and abuts against the adjacent surface of a rear prism portion that is one of the plurality of incident prism portions adjacent to the reflective surface.

### BRIEF DESCRIPTION OF DRAWINGS

Objects, features and advantages of the present disclosure will become more apparent from the following detailed description made with reference to the accompanying drawings, in which:

FIG. 1 is a cross-sectional view of an optical member according to a first embodiment;

FIG. 2 is an exploded perspective view of an optical member according to the first embodiment;

FIG. 3 is an explanatory diagram for explaining a light guided in the optical member, an occurrence of a ghost image in a case assumed where there is no back cover, and suppression of the occurrence of the ghost image by the back cover, in the optical member according to the first embodiment;

FIG. 4 is an enlarged view of a contact portion between the back cover and an incident prism portion;

FIG. 5 is an exploded perspective view of an optical member according to a second embodiment;

FIG. 6 is an end view when the optical member is viewed along an arrow VI in FIG. 5;

FIG. 7 is a cross-sectional view taken along a line VII-VII in FIG. 5 in a state where a light guide body is attached to a holder;

FIG. 8 is a perspective view showing another example of the shape of the holder according to the second embodiment;

FIG. 9 is an end view of an optical member according to a third embodiment, and corresponding to FIG. 6;

FIG. 10 is an exploded perspective view of a holder according to the third embodiment;

FIG. 11 is an exploded perspective view of an optical member according to a fourth embodiment; and

FIG. 12 is a cross-sectional view taken along a line XII-XII in FIG. 11 in a state where a light guide body is attached to a holder.

### DETAILED DESCRIPTION

An optical member that is attached to a light-shielding body and used as a blind spot auxiliary device allows an external scenery light from a blind spot area caused by the light shielding body to enter the inside from an incident surface, reflects the external scenery light in the inside, and exits the external scenery light from a surface that is different from the incident surface, thereby causing the blind spot area to be viewed by a user. Such an optical member is, for example, described in JP 2023-028532 A, which corresponds to US 2023/0058463 A1.

The optical member described in JP 2023-028532 A includes a translucent light guide body that guides inside a part of external light entering from an incident surface of the light guide body by total reflection and exits the light from an exit portion different from the incident surface to the outside, thereby causing a user present on the exit surface side to see an external view in a blind spot. Thus, the optical member has a half-mirrorless structure that does not require a half-mirror, which is made of a reflective material different from the light guide body, on the exit side. As a result, the optical member can reduce loss due to absorption of external light when the external light is guided inside the light guide body and variations in brightness due to wavelength.

The optical member described in JP 2023-028532 A has the light guide body made of a light-transmitting material. Therefore, when the light guide body is attached to another light-shielding body, an external scenery light is incident on a surface of the light guide body that is other than the incident surface and faces the light-shielding body. In this optical member, when the external scenery light entering the light guide body from the surface other than the incident surface is exited from the exit surface, this light is visually recognized by a user as a ghost image.

To address issue, it is conceivable to form a light-shielding film on surfaces of the light guide body made of the light-transmitting material, the surfaces being other than the incident surface and the exit surface. However, in the optical member described above, since the light guide body is configured to guide the incident light by total reflection, if the light-shielding film is formed, it is difficult to satisfy the condition of total reflection. As a result, a user on the exit surface side will not be able to see the external scenery light of the blind spot.

The present disclosure provides an optical member that uses a light guide body made of a light-transmitting material and is capable of suppressing an occurrence of ghost image due to an incident light entering from a surface other than the incident surface.

According to an aspect of the present disclosure, an optical member includes a light guide body and a light-shielding back cover. The light guide body is made of a light-transmitting material. The light guide body has an incident part including a plurality of protruding incident prism portions, a reflective surface adjacent to the incident part, and an exit surface facing the incident part and the reflective surface. The exit surface allows a part of an incident light entering inside of the light guide body from the incident part to exit to an outside of the light guide body and allows another part of the incident light to reflect toward the reflective surface by a total reflection. The light-shielding back cover covers at least an entire area of the reflective surface of the light guide body. Each of the plurality of incident prism portions has an incident surface that allows an external scenery light to enter the inside of the light guide body and an adjacent surface adjacent to the incident surface, one of the plurality of incident prism portions that is adjacent to the reflective surface is referred to as a rear prism portion. The back cover abuts against the adjacent surface of the rear prism portion and faces the reflective surface across a gap.

According to the aspect, the optical member includes the mirrorless light guide body that can guide light by total reflection, and the back cover, and in which the back cover covers the entire reflective surface of the light guide body, which faces a light shielding body (not shown), across the gap. As such, the optical member using the mirrorless light guide body can suppress the occurrence of ghost images that are caused by the light, which has entered the light guide body from the surfaces other than the incident surface, reaching the reflective surface.

Hereinafter, embodiments of the present disclosure will be described with reference to the drawings. In the following description, the same or equivalent parts are denoted by the same reference numerals throughout the embodiments.

### First Embodiment

An optical member 1 according to the first embodiment will be described.

### Basic Configuration:

The optical member 1 according to the first embodiment is attached, for example, to a member or obstacle that blocks the user's field of vision and causes a blind spot, and is used as a blind spot auxiliary device that allows the user to visually recognize the view in the blind spot area. In a case where the optical member 1 is used for a vehicle, for example, the optical member 1 is attached to a predetermined light-shielding body, such as a pillar of the vehicle, and directs an external scenery light from an area that is a blind spot due to the light-shielding body to the user's side, thereby to allow the user to see the scene in the blind spot area.

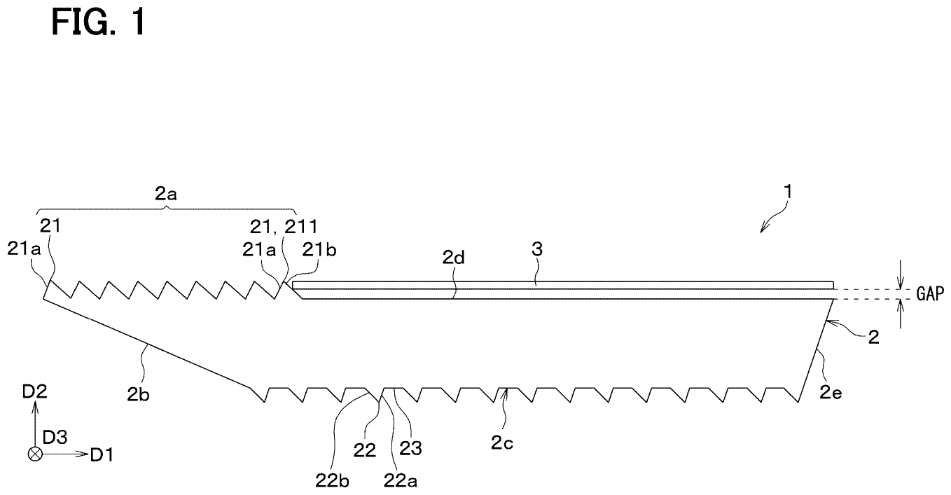

The optical member 1 of the present embodiment has a light guide body 2 and a back cover 3, as shown in FIG. 1, for example. The optical member 1 is used in a state where the light guide body 2 and the back cover 3 are attached to a light shielding body (not shown) so that the back cover 3 faces the light shielding body. The optical member 1 is configured to guide an external scenery light inside the light guide body 2 and exit it toward the user side so as to allow the user to see the blind spot area, as well as to suppress unnecessary light from entering the light guide body 2 by means of the back cover 3.

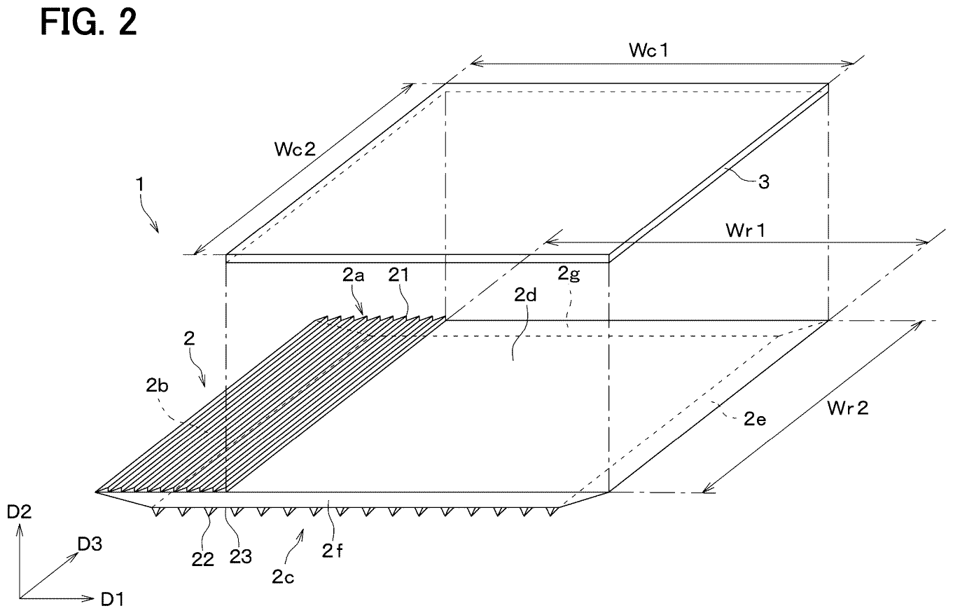

As shown in FIG. 1, for example, the light guide body 2 is an element having an incident part 2a, a reflective surface 2d adjacent to the incident part 2a, an exit surface 2c facing the incident part 2a and the reflective surface 2d, a side surface 2b connecting the incident part 2a and the exit surface 2c, and a terminal surface 2e connecting the exit surface 2c and the reflective surface 2d. As shown in FIG. 2, the light guide body 2 has an upper surface 2f and a lower surface 2g that are opposed to each other and connect the incident part 2a, the side surface 2b, the exit surface 2c, the reflective surface 2d and the terminal surface 2e. For example, the light guide body 2 is a single transparent member made of a light-transmitting material. Examples of the light-transmitting material that can be used herein include a resin material such as polyethylene terephthalate, polycarbonate, polyethylene, and acrylic, and an inorganic material such as glass. The light guide body 2 has a mirrorless structure that does not have a mirror made of a reflective material different from the light-transmitting material, and is designed to guide an incident light incident on the incident part 2a by totally reflecting inside thereof. The light guide body 2 has many similar configurations with the light guide body described in JP 2023-028532 A, and therefore, the disclosure of JP 2023-028532 A is incorporated herein by reference. Hereinafter, the characteristic parts of the present disclosure will be mainly described.

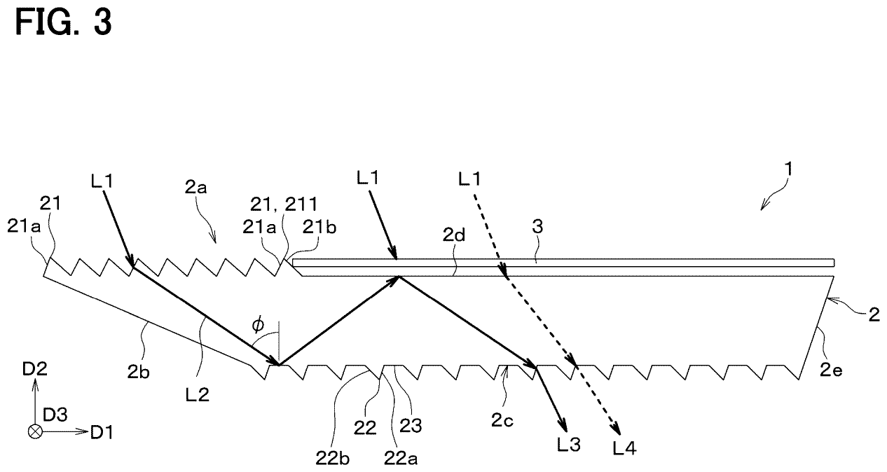

As shown in FIG. 1, for example, the incident part 2a is composed of multiple incident prism portions 21 that are projections with a triangular shape in a cross-sectional view. The incident prism portions 21 are repeatedly and continuously arranged in an arrangement direction with the same extension direction. As shown in FIG. 3, for example, of the outer surfaces of each of the multiple incident prism portions 21, one being further from the reflective surface 2d, which is adjacent to the incident part 2a, serves as an incident surface 21a that allows a part of the external scenery light L1 to enter the inside of the light guide body 2. For example, the multiple incident prism portions 21 are arranged such that the heights of portions protruding from the reflective surface 2d are substantially the same and the incident surfaces 21a are substantially parallel to each other. The phrase “substantially the same” includes not only the case where they are completely the same, but also the case where they are almost the same due to unavoidable errors, such as processing errors, although they are not completely the same. Of the outer surfaces of each of the multiple incident prism portions 21, one being closer to the reflective surface 2d is referred to as an adjacent surface 21b. The adjacent surface 21b has an inclination angle equal to or smaller than a predetermined value so as not to impede the incidence of the external scenery light L1 onto the incident surface 21a of the adjacent incident prism portion 21.

For ease of explanation, as shown in FIG. 3, of the external scenery lights L1 on the sides of the incident part 2a and the reflective surface 2d, the light that enters the inside of the light guide body 2 from the incident part 2a is referred to as the “incident light L2”, and the light that exits to the outside of the light guide body 2 from an exit prism portion 22, which will be described layer, is referred to as the “exit light L3”. In FIG. 2, in order to make the configuration of the optical member 1 easier to understand, some portions of the outlines of the light guide body 2 and the back cover 3 that cannot be seen from the angle of FIG. 2 are shown by dashed lines.

Assumed that an incident angle of the incident light L2 to a flat portion 23 is defined as φ. For example, an inclination angle of the side surface 2b is equal to or greater than the incident angle φ so as to restrict the incident light L2 from exiting to the outside from the side surface 2b. The incident angle φ of the incident light L2 is an angle defined between a direction normal to the plane of the flat portion 23 or the reflective surface 2d (hereinafter simply referred to as the “normal direction”) and a traveling direction of the incident light L2. The light guide body 2 is capable of guiding light with a mirrorless structure by satisfying a total reflection condition expressed by the following expression (1), in which n is a refractive index of a constituent material and an external medium is air (refractive index=1).

$$sin φ \geq 1 / n \qquad ( 1 )$$

The exit surface 2c has, for example, multiple exit prism portions 22 that are protrusions with triangular shapes in a cross-sectional view, and multiple flat portions 23 that are flat surfaces substantially parallel to the reflective surface 2d and are adjacent to the exit prism portions 22. The exit surface 2c is the surface onto which the incident light L2 from the incident part 2a first reaches, and is configured by alternately arranging the exit prism portions 22 and the flat portions 23 in a repeated manner. The multiple exit prism portions 22 each have an exit portion 22a that is a surface from which the incident light L2 exits to the outside, and another surface 22b that is adjacent to the surface of the exit portion 22a. The multiple exit prism portions 22 are, for example, arranged in parallel to each other with the same extension direction. The exit portions 22a are, for example, parallel to the incident surfaces 21a. The multiple flat portions 23 are, for example, flat surfaces located on the same plane, and serve as first reflective surfaces that reflect the incident light L2 toward the reflective surface 2d by the total reflection.

For ease of explanation, the direction perpendicular to the extension direction of the exit prism portions 22 and along the arrangement direction of the multiple exit prism portions 22 will be referred to as a “first direction D”, and the direction along the normal direction will be referred to as a “second direction D2”. The direction along the extension direction of the incident prism portions 21 and the extension direction of the exit prism portions 22 is referred to as a “third direction D3”. Of directions parallel to the first direction D1, the direction from the side surface 2b toward the terminal surface 2e corresponds to a light guide direction in which the incident light L2 is guided. The second direction D2 corresponds to the thickness direction of the light guide body 2.

The reflective surface 2d serves as a second reflective surface that reflects the incident light L2 reflected by the flat portion 23 toward the exit surface 2c by total reflection. When the exit surface 2c facing the user side is referred to as a front surface, the reflective surface 2d is a back surface. The entire area of the reflective surface 2d is covered with the back cover 3 across a gap, and the back cover 3 restricts the external scenery light L1 from being incident on the reflective surface 2d.

If it is assumed that there is no back cover 3, as shown by the dashed arrow in FIG. 3, a part of the external scenery light L1 is directly incident on the reflective surface 2d and enters the inside. This incident light exits from the exit surface 2c as unintended ghost light L4. If the ghost light L4 reaches the user's eye together with the exit light L3, the user will see the scene due to the ghost light L4 together with the scene of the blind spot area provided by the exit light L3. In order to suppress the occurrence of such ghost images and improve the visibility of the blind spot area, the optical member 1 has the configuration in which the back cover 3 restricts the external scenery light L1 from being incident on the reflective surface 2d.

The terminal surface 2e is the surface where a part of the incident light L2 finally reaches. The terminal surface 2e may form a single plane together with the exit portion 22a of the exit prism portion 22, or may have another surface shape. The terminal surface 2e may have any shape.

The upper surface 2f and the lower surface 2g are non-optical surfaces that are not used for guiding the incident light L2 inside the light guide body 2, that is, not used for reflecting the incident light L2, similar to the side surface 2b. For example, each of the upper surface 2f and the lower surface 2g is a single flat surface connecting the incident part 2a, the exit surface 2c, the reflective surface 2d, and the terminal surface 2e. Also, the upper surface 2f and the lower surface 2g are arranged in parallel, for example. However, the upper surface 2f and the lower surface 2g may have any shape as long as they do not interfere with the guide of the incident light L2.

The back cover 3 is a light blocking member that restricts the external scenery light L1 from being incident on the reflective surface 2d. The back cover 3 may be, for example, a flat plate. The back cover 3 may be entirely made of any light-shielding material such as resin or metal, or may have a configuration in which some or all outer surfaces are painted with black paint or the like. In this way, the back cover 3 may be configured to be opaque to light, and the material and configuration may be changed as appropriate. For example, the back cover 3 is preferably made of a black light-shielding material having a visible light absorptance of a predetermined value or more.

It is preferable that the surface of the back cover 3 facing the reflective surface 2d is a rough surface that reflects light less easily than a mirror surface. In such a case, for example, when the external light from the exit surface 2c enters the light guide body 2 and exits from the reflective surface 2d to the back cover 3, the facing surface of the back cover 3 restricts reflection of this exit light. As a result, the visibility of the blind spot area that is made visible to the user by the exit surface 2c is further improved. The term “rough surface” used here means a surface that has not been subjected to a flattening treatment, such as mirror finishing, to reduce the surface roughness to a predetermined level or less.

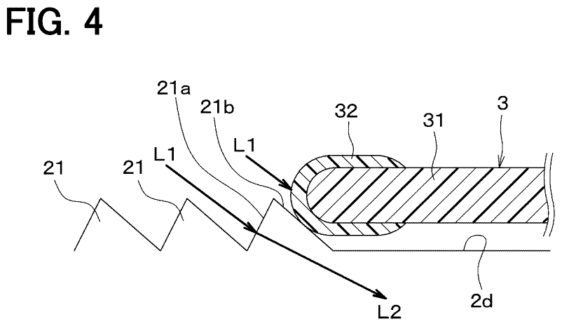

For example, the back cover 3 includes a plate member 31 and an elastic body 32 attached to an end portion of the plate member 31, as shown in FIG. 4. The plate member 31 may have any suitable structure that does not transmit light. The back cover 3 is arranged such that the elastic body 32 abuts against the adjacent surface 21b of a rear prism portion 211 that is one of the multiple incident prism portions 21 located closest to the reflective surface 2d. The elastic body 32 is a light shielding and elastic member, such as a black rubber. The elastic body 32 serves to restrict the rear prism portion 211 from being damaged by the back cover 3 abutting thereon while filling a gap between the rear prism portion 211 and the plate member 31 so as to restrict the light from reaching the reflective surface 2d. The back cover 3 is disposed so that the plate member 31 and the elastic body 32 are spaced from the reflective surface 2d with the gap so as not to be in contact with the reflective surface 2d, thereby not to impede the total reflection of the incident light L2 on the reflective surface 2d.

If a light-shielding film is formed on the reflective surface 2d of the light guide body 2 by applying a black paint, the total reflection condition of the above expression (1) will no longer be satisfied, and the light-guiding function will be impaired. Therefore, in the light guide body 2 with the mirrorless structure, it is not possible to directly apply a light-shielding treatment to the reflective surface 2d.

The width of the reflective surface 2d of the light guide body 2 in the first direction D1 is defined as Wr1, and the width of the reflective surface 2d in the third direction D3 is defined as Wr2. Also, the width of the back cover 3 in the first direction D1 is defined as Wc1, and the width of the back cover 3 in the third direction D3 is defined as the width Wc2. In this case, the width Wr1 of the back cover 3 is equal to or greater than the width Wr1 of the reflective surface 2d in the first direction D1, and the width Wc2 of the back cover 3 is equal to or greater than the width Wr2 of the reflective surface 2d in the third direction D3. In other words, the back cover 3 has a planar size equal to or larger than the reflective surface 2d so as to cover the entire reflective surface 2d. As a result, the back cover 3 restrict the incident of the external scenery light L1 on the reflective surface 2d, and suppresses the occurrence of ghost images.

According to the present embodiment, the optical member 1 has the mirrorless light guide body 2 capable of guiding light by total reflection, and the back cover 3 that covers the entire area of the reflective surface 2d of the light guide body 2, which faces a light shielding body (not shown), across the gap between the facing surface of the back cover 3 and the reflective surface 2d. Thus, the optical member 1 can suppress the occurrence of ghost images caused by the light entering from a surface other than the incident surface 21a of the light guide body 2, while using the light guide body 2 with the mirrorless structure. In addition, the optical member 1 also achieves the following effects.

(1) In the optical member 1, the facing surface of the back cover 3 facing the light guide body 2 is the rough surface that has not been smoothed. As such, it is possible to suppress the surface reflection of the light on the facing surface of the back cover 3 as well as to restrict unintended light from traveling toward the exit surface 2c. Accordingly, it possible to further improve the visibility of the blind spot area on the exit surface 2c side.

(2) In the optical member 1, the portion of the back cover 3 that abuts against the rear prism portion 211 of the light guide body 2 is provided by the light-shielding elastic body 32. As such, it is possible to suppress the light guide body 2 from being scratched by the back cover 3, as well as to fill the gap at the contact point between the rear prism portion 211 of the light guide body 2 and the back cover 3. Accordingly, it is possible to further suppress the external scenery light L1 from being directly incident on the reflective surface 2d.

### Second Embodiment

An optical member 1 according to a second embodiment will be described.

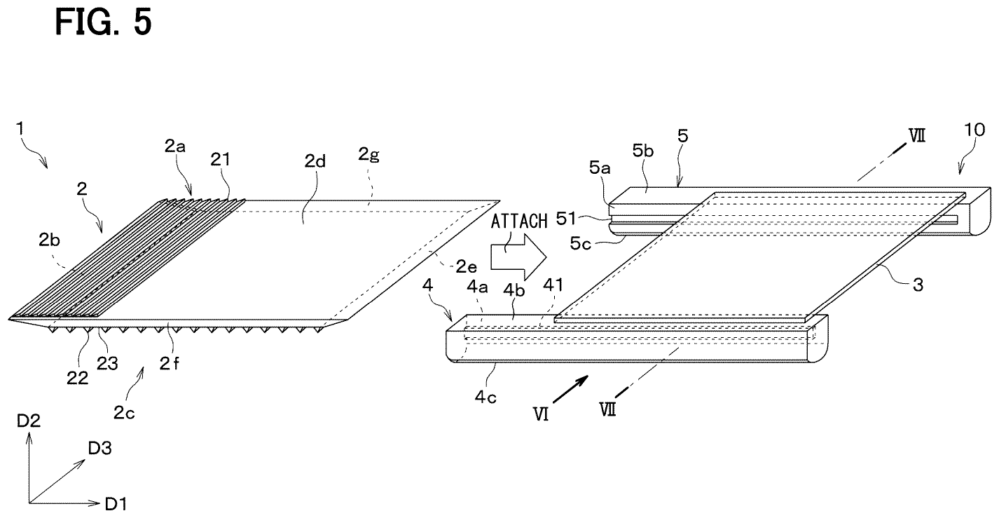

As shown in FIG. 5, for example, the optical member 1 of the present embodiment differs from the optical member 1 of the first embodiment in that it has a holder 10 that constitutes the back cover 3 as a part and holds the light guide body 2. Hereinafter, this difference will be mainly described.

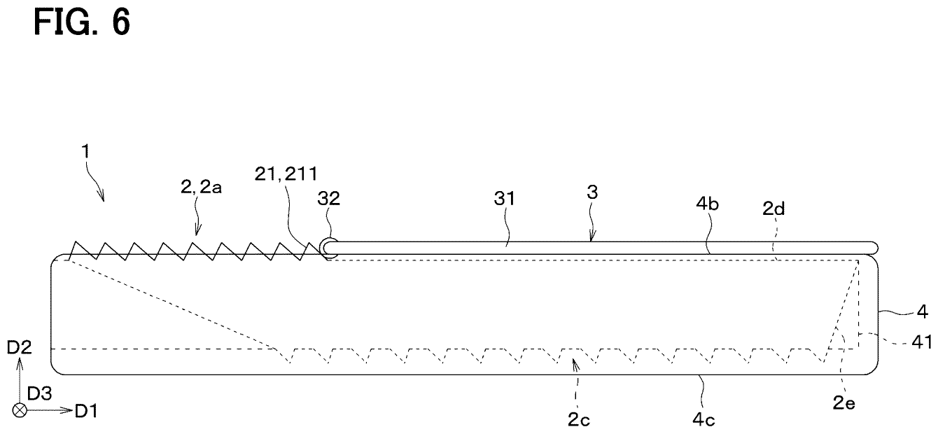

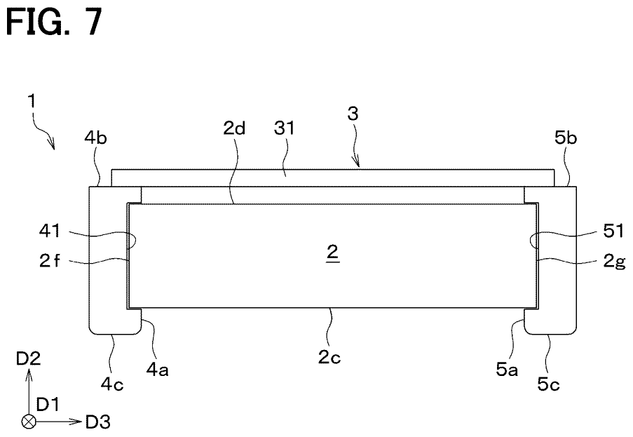

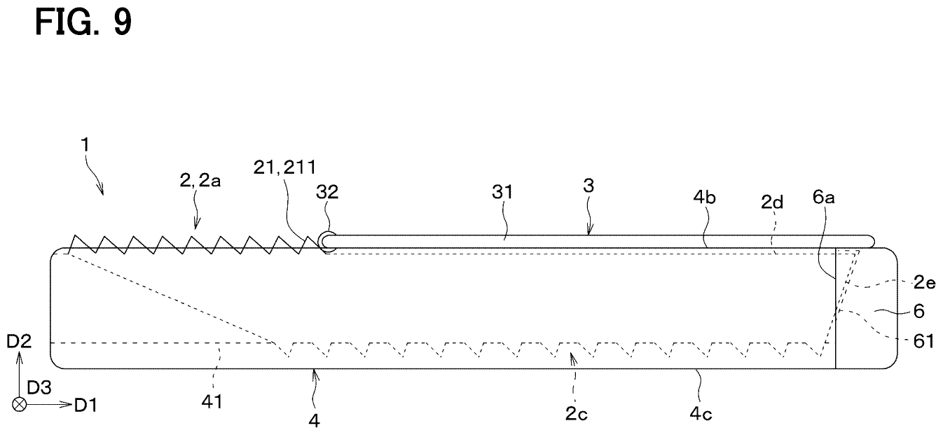

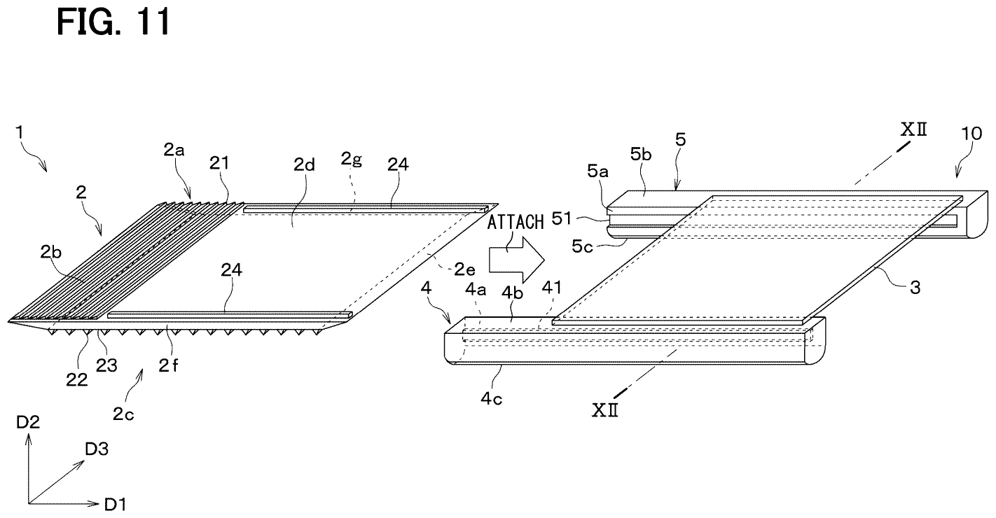

In FIG. 5, similar to FIG. 1, portions of the outlines of the light guide body 2 that are not visible from the angle in FIG. 5 are shown by dashed lines. Likewise, portions of the outlines of the upper cover 4 and the lower cover 5, which will be described later, are also shown by dashed lines. The same applies to FIG. 11, which will be described later. In FIG. 6, the outer contour of the portion of the light guide body 2 that overlaps with the holder 10 and the outer contour of the upper cover 4 that are not visible from the angle in FIG. 6 are shown by dashed lines. The same applies to FIG. 9, which will be described later. FIG. 7 is a cross-sectional view defined at the position of the flat portion 23 of the exit surface 2c.

As shown in FIG. 5, for example, the holder 10 includes the back cover 3, the upper cover 4 and the lower cover 5.

The upper cover 4 is a member that faces the upper surface 2f of the light guide body 2 and holds the upper surface 2f of the light guide body 2. The upper cover 4 has a facing surface 4a that faces the upper surface 2f of the light guide body 2. The upper cover 4 has a recess 41, as a groove, for holding the light guide body 2 on the facing surface 4a. As shown in FIG. 6, for example, the upper cover 4 has an end surface 4b that is adjacent to the facing surface 4a and is located closer to the reflective surface 2d than the exit surface 2c of the light guide body 2, and the back cover 3 is attached to the end surface 4b of the upper cover 4. The upper cover 4 has a width in the first direction D1 greater than the width of the back cover 3 in the first direction D1, and covers the entire upper surface 2f of the light guide body 2. The upper cover 4 has an exit-side surface 4c on a side opposite to the end surface 4b, and ends of the exit-side surface 4c have curved shapes as being chamfered. As a result, the surface of the upper cover 4 that faces the user has a rounded shape without having any edged corners, thereby to restrict the user from getting injured.

The lower cover 5 is a member that forms a pair with the upper cover 4, and is used to hold the light guide body 2 together with the upper cover 4. For example, the lower cover 5 has a facing surface 5a that faces the lower surface 2g of the light guide body 2. The lower cover 5 has a recess 51, as a groove, for holding the light guide body on the facing surface 5a. The lower cover 5 has a width in the first direction D1 greater than the width of the back cover 3 in the first direction D1, and covers the entire lower surface 2g of the light guide body 2. The lower cover 5 has basically the same structure as the upper cover 4, as shown in FIG. 7, for example. The back cover 3 is attached to the end surface 5b of the lower cover 5, which is adjacent to the facing surface 5a and is located closer to the reflective face 2d than the exit surface 2c of the light guide body 2. For the same reason as in the case of the upper cover 4, end portions of an exit-side surface 5c of the lower cover 5, which is opposite to the end surface 5b, have curved shapes as being chamfered.

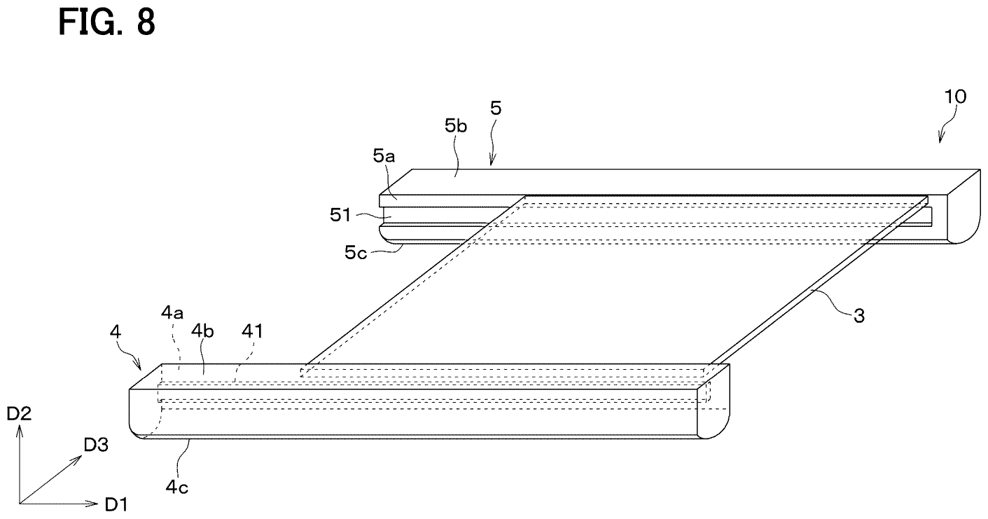

The back cover 3 may be integral with the upper cover 4 and the lower cover 5 or may be separate from the upper cover 4 and the lower cover 5. In the latter case, the back cover 3 is attached to the upper cover 4 and the lower cover 5 by any method, such as fastening members such as screws (not shown) or adhesives. The back cover 3 is attached to the upper cover 4 and the lower cover 5 at a position adjacent to the end faces 4b and 5b than the recesses 41 and 51 of the upper cover 4 and the lower cover 5 so as to connect the upper cover 4 and the lower cover 5. As such, the holder 10 can hold the light guide body 2 while ensuring the gap between the reflective surface 2d of the light guide body 2 and the back cover 3. As shown in FIG. 8, for example, the back cover 3 may be attached to the facing surfaces 4a and 5a at positions that are closer to the end surfaces 4b and 5b than the recesses 41 and 51, rather than on the end surfaces 4b and 5b of the upper cover 4 and the lower cover 5.

It is preferable that at least the surface of the upper cover 4 and the surface of the lower cover 5 that face the light guide body 2 are rough surfaces with the light shielding property. In such a case, it is possible to suppress the incident of the external light on the upper surface 2f or the lower surface 2g of the light guide body 2 from the upper cover 4 or the lower cover 5, and to suppress surface reflection of light on the facing surfaces 4a and 5a. Therefore, it is less likely that unintended light will reach the exit surface 2c, and hence the visibility of the blind spot area improves. Similar to the back cover 3, the upper cover 4 and the lower cover 5 are entirely or partially made of any light-shielding material.

In the present embodiment, for example, the light guide body 2 is configured so that both ends of the incident prism portion 21 and the exit prism portion 22 do not reach the upper surface 2f and the lower surface 2g, as shown in FIG. 5, so that the light guide body 2 is attachable to the upper cover 4 and the lower cover 5. In such a case, the light guide body 2 is inserted to the recess 41 of the upper cover 4 and the recess 51 of the lower cover 5 while avoiding interference of the prism portions 21 and 22 of the light guide body 2 with the recesses 41 and 51, and is held by the holder 10. Furthermore, the light guide body 2 may have any shape as long as it can be attached to the holder 10. The light guide body 2 may be configured to have protrusions on the upper surface 2f and the lower surface 2g with dimensions matching the width of the recess 41 and the recess 51. Further, the structure of the light guide body 2 may be modified as appropriate within the range that does not interfere with the guide of the incident light L2. The same applies to the upper cover 4 and the lower cover 5.

According to the present embodiment, in addition to the structure of the first embodiment described above, the optical member 1 has the structure that is capable of holding the light guide body 2 and the back cover 3 while maintaining the positional relationship between the light guide body 2 and the back cover 3, and is capable of being fixed to the light blocking body (not shown). In addition, the optical member 1 achieves the following effects.

(1) The optical member 1 has a structure in which the upper cover 4 and the lower cover 5 have the recess 41 and the recess 51 for holding the light guide body 2, respectively. As a result, in the optical member 1, the light guide body 2 is held in a state of being fitted in the recess 41 of the upper cover 4 and the recess 51 of the lower cover 5, which are in pair in the holder 10.

(2) In the optical member 1, the back cover 3 is attached so as to connect the upper cover 4 and the lower cover 5 at the positions closer to the end surfaces 4b and 5b than the recesses 41 and 51 of the upper and lower covers 4 and 5. As a result, the optical member 1 has a structure in which the light guide body 2 is held by the holder 10 while securing the gap between the reflective surface 2d of the light guide body 2 and the back cover 3.

(3) In the optical member 1, the surface of the upper cover 4 and the surface of the lower cover 5, which face the light guide body 2, are the light-shielding rough surfaces. In this case, it is possible to suppress the intrusion of external light into the light guide body 2 from the upper cover 4 and the lower cover 5, and the surface reflection of light on the surfaces of the upper and lower covers 4 and 5 facing the light guide body 2. As such, the visibility of the blind spot area provided by the light guide body 2 further improves.

(4) In the optical member 1, the width of each of the upper cover 4 and the lower cover 5 in the first direction D1 corresponding to the light guide direction is greater than that of the back cover 3, so that the upper cover 4 and the lower cover 5 entirely cover the upper surface 2f and the lower surface 2g, respectively. In this case, it is possible to suppress the intrusion of unintended external light onto the upper surface 2f and the lower surface 2g of the light guide body 2. As such, the visibility of the blind spot area provided by the light guide body 2 further improves.

(5) In the optical member 1, the ends of the exit-side surfaces 4c and 5c of the upper and lower covers 4 and 5 have the curved shapes without having edged corners. Therefore, the holder 10 has the rounded shape without sharp edges on the user's side ends. As such, the optical member 1 has a structure that can restrict the user from getting injured.

### Third Embodiment

An optical member 1 according to a third embodiment will be described.

As shown in FIG. 9, the optical member 1 of the present embodiment differs from the optical member 1 of the second embodiment in that the holder 10 further includes a rear cover 6. Hereinafter, this difference will be mainly described.

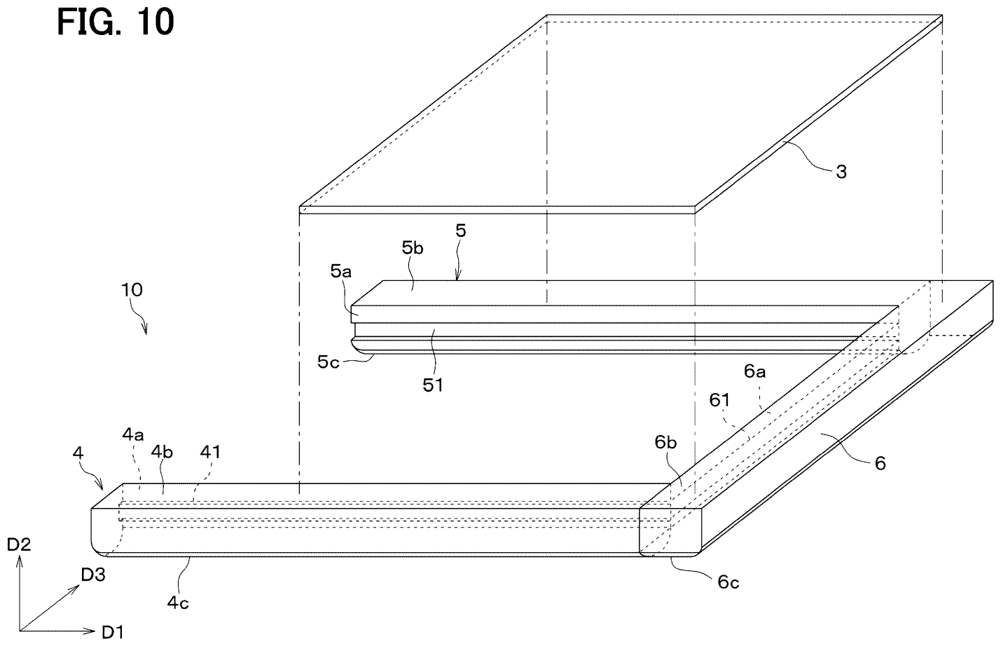

In FIGS. 9 and 10, portions of the outlines of the rear cover 6 that cannot be seen from the angle in FIG. 9 are shown by dashed lines. In FIG. 10, similar to FIG. 2, portions of the outlines of the back cover 3 that cannot be seen in FIG. 10 are shown by dashed lines.

In the present embodiment, the holder 10 has the rear cover 6 that covers the terminal surface 2e of the light guide body 2, in addition to the back cover 3, the upper cover 4 and the lower cover 5. The side surface 2b and the terminal surface 2e of the light guide body 2 are referred to as the front surface and the rear surface of the light guide body 2, respectively. In the present embodiment, the holder 10 covers the terminal surface 2e, in addition to the upper surface 2f and the lower surface 2g. Thus, the part of the holder 10 excluding the back cover 3 has the U-shape.

The rear cover 6 is a member that connects the upper cover 4 and the lower cover 5, and holds the light guide body 2 while covering the terminal surface 2e side of the light guide body 2. The rear cover 6 has a recess 61, as a groove, on a facing surface 6a that faces the terminal surface 2e of the light guide body 2 for holding the light guide body 2. The recess 61 may have any shape as long as it fits with a part or the whole of the terminal surface 2e, and the shape, dimensions and the like of the recess 61 may be appropriately changed according to the shape and the like of the terminal surface 2e of the light guide body 2. For example, a width of the rear cover 6 in the third direction D3 is greater than the width of the back cover 3 in the third direction D3. Thus, the rear cover 6 covers the entire terminal surface 2e of the light guide body 2. The rear cover 6 has basically the same structure as the upper cover 4 and the lower cover 5, for example, as shown in FIG. 10. The rear cover 6 has an end surface 6b that is adjacent to the facing surface 6a and is located closer to the reflective surface 2d of the light guide body 2 than the exit surface 2c. The back cover 3 is attached to the end surface 6b of the rear cover 6. For the same reasons as those for the upper cover 4 and the lower cover 5, the rear cover 6 has the curved shape as being chamfered at ends of an exit-side surface 6c, which is on a side opposite to the end surface 6b.

In the present embodiment, in the upper cover 4 and the lower cover 5, for example, the ends of the exit-side surfaces 4c and 5c, excluding the portions adjacent to the rear cover 6, have the curved shapes as chamfered, and the portions of the ends of the exit-side surfaces 4c and 5c adjacent to the rear cover 6 form a flat surface without any steps as being attached to the rear cover 6.

The rear cover 6 may be integral with some or all of the back cover 3, upper cover 4, and lower cover 5, or may be separate. When the rear cover 6 is a separate member, the rear cover 6 is attached to the upper cover 4 and the like by any method such as a fastening member or an adhesive, though not shown. In the case where the holder 10 has the rear cover 6, the holder 10 achieves the structure that can more stably hold and fix the light guide body 2 while suppressing misalignment with the upper cover 4 and the lower cover 5. Also in the present embodiment, the back cover 3 may be attached to the portions of the facing surfaces 4a, 5a, and 6a, as ribs, that are closer to the end surfaces 4b, 5b and 6b than the recesses 41, 51, and 61. In addition, it is preferable that the thicknesses, that is, the widths in the second direction D2 of such ribs of the covers 4, 5, and 6 other than the portions facing the incident prism portions 21 are increased, so that the gap between the back cover 3 and the reflective surface 2d of the light guide body 2 can be securely ensured.

It is preferable that at least the facing surface 6a of the rear cover 6 is the rough surface having the light shielding property, for example. In this case, it is possible to suppress the unintended intrusion of external light into the terminal surface 2e through the rear cover 6 and the surface reflection of the light on the facing surface 6a of the rear cover 6, and hence the visibility of blind spots area provided by the light guide body 2 improves. Similar to the upper cover 4 and the lower cover 5, not only the facing surface 6a but also the entirety of the rear cover 6 may be made of any material having the light-shielding property.

According to the present embodiment, in addition to the effects achieved by the second embodiment, the optical member 1 can more stably hold and fix the light guide body 2 while suppressing the misalignment of the upper cover 4 and the lower cover 5. In addition, the optical member 1 also achieves the following effects.

(1) In the optical member 1, at least the surface of the rear cover 6 that faces the light guide body 2 is the rough surface having the light-shielding property. In this case, it is possible to achieve the effects of suppressing the intrusion of external light into the terminal surface 2e through the rear cover 6 and the surface reflection of light on the facing surface 6a, as well as the effect of further improving the visibility of the blind spot area provided by the light guide body 2.

(2) In the optical member 1, the rear cover 6 has the recess 61 on the facing surface 6a thereof for holding the light guide body 2. In this case, it is possible to hold the light guide body 2 not only by the upper cover 4 and the lower cover 5 but also by the rear cover 6, so that the light guide body 2 is fixed more stably.

(3) Similar to the upper cover 4 and the lower cover 5, the ends of the exit-side surface 6c of the rear cover 6 have the curved shapes without any edged corners. Therefore, the optical member 1 provides the structure that can suppress injury to the user.

### Fourth Embodiment

An optical member 1 according to a fourth embodiment will be described.

The optical member 1 of the present embodiment differs from the optical member 1 of the second embodiment in that the light guide body 2 is formed with a rib 24 at a position near the end of the reflective surface 2d, as shown in FIG. 11. Hereinafter, this difference will be mainly described.

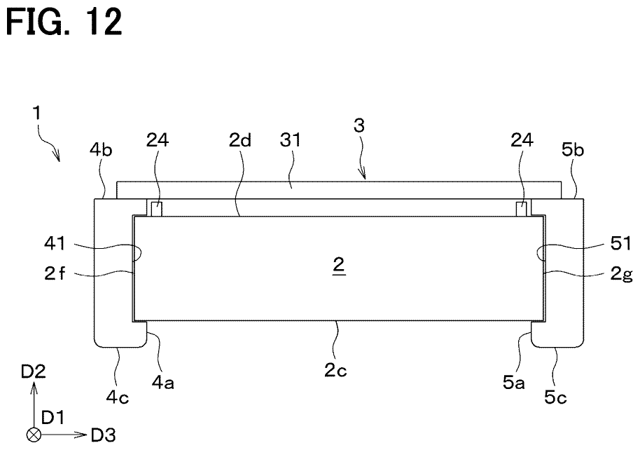

In the present embodiment, the light guide body 2 has ribs 24, as protrusions, on the reflective surface 2d at positions adjacent to the upper surface 2f and the lower surface 2g. The ribs 24 protrude from the reflective surface 2d. As shown in FIG. 12, for example, the light guide body 2 has two ribs 24. The two ribs 24 are formed at positions that are located more to inside than the portions of the reflective surface 2d inserted into the recess 41 of the upper cover 4 and the recess 51 of the lower cover 5, and are at the ends or in the vicinity of the ends in the third direction D3. For example, the two ribs 24 extend linearly along the first direction D1 and are arranged in parallel. The ribs 24 are parts that restrict the back cover 3 from coming into contact with the reflective surface 2d of the light guide body 2, which results in inhibition of the total reflection of the incident light L2 at the reflective surface 2d, even if the back cover 3 is deformed, for example, due to heat.

The ribs 24 are, for example, provided as parts of the light guide body 2, and formed by a molding method using a mold (not shown) in a similar manner to the prism portions 21 and 22. The ribs 24 are formed on both ends in the third direction D3 or in the vicinities thereof, and may have any number, shape, or the like as long as the ribs 24 can restrict the back cover 3 from coming into contact with the reflective surface 2d.

According to the present embodiment, the optical member 1 has the structure that more reliably restricts the back cover 3 from coming into contact with the reflective surface 2d of the light guide body 2, in addition to the effects achieved by the second embodiment.

### Other Embodiments

Although the present disclosure has been described in accordance with the embodiments, it is understood that the present disclosure is not limited to such embodiments and structures. The present disclosure encompasses various modifications and variations within the scope of equivalents. In addition, various combinations and modes, and other combinations and modes that include only one element, more element, or less elements are within the scope and concept range of the present disclosure.

The constituent element(s) of each of the embodiments described above is/are not necessarily essential unless it is specifically stated that the constituent element(s) is/are essential in the description of the embodiment, or unless the constituent element(s) is/are obviously essential in principle. Further, in each of the embodiments described above, when numerical values such as the number, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Furthermore, a material, a shape, a positional relationship, or the like, if mentioned in each of the embodiments described above, is not necessarily limited to the specific shape, positional relationship, or the like unless it is specifically stated that the material, shape, positional relationship, or the like is necessarily the specific material, shape, positional relationship, or the like, or unless the shape, positional relationship, or the like is obviously necessary to be the specific shape, positional relationship, or the like in principle.

What is claimed is:

1. An optical member comprising:
a light guide body made of a light-transmitting material, the light guide body having an incident part including a plurality of protruding incident prism portions, a reflective surface adjacent to the incident part, and an exit surface facing the incident part and the reflective surface, the exit surface allowing a part of an incident light entering inside of the light guide body from the incident part to exit to an outside of the light guide body and allowing another part of the incident light to reflect toward the reflective surface by a total reflection; and
a light-shielding back cover that covers at least an entire area of the reflective surface of the light guide body, wherein
each of the plurality of incident prism portions has an incident surface that allows an external scenery light to enter the inside of the light guide body and an adjacent surface adjacent to the incident surface,
one of the plurality of incident prism portions that is adjacent to the reflective surface is referred to as a rear prism portion, and
the back cover abuts against the adjacent surface of the rear prism portion and faces the reflective surface across a gap.

2. The optical member according to claim 1, wherein
a surface of the back cover that faces the reflective surface is a rough surface.

3. The optical member according to claim 1, wherein
a portion of the back cover that abuts against the rear prism portion is provided by a light-shielding elastic body.

4. The optical member according to claim 1, wherein
the light guide body has an upper surface and a lower surface that connect the incident part, the exit surface and the reflective surface,
the optical member further comprising:
a holder that holds the light guide body, wherein
the holder includes the back cover, an upper cover and a lower cover,
the upper cover faces and holds the upper surface of the light guide body, and
the lower cover faces and holds the lower surface of the light guide body.

5. The optical member according to claim 4, wherein
the upper cover is formed with a recess in which the upper surface of the light guide body is held, and
the lower cover is formed with a recess in which the lower surface of the light guide body is held.

6. The optical member according to claim 5, wherein
each of the upper cover and the lower cover has an end surface that is adjacent to a surface on which the recess is defined, and is closer to the reflective surface than the exit surface of the light guide body, and
the back cover is attached to the upper cover and the lower cover so as to connect the upper cover and the lower cover at positions closer to the end surfaces of the upper cover and the lower cover than the recesses.

7. The optical member according to claim 4, wherein
a surface of each of the upper cover and the lower cover facing the light guide body is a light-shielding and rough surface.

8. The optical member according to claim 4, wherein
a direction that is orthogonal to an extension direction of the plurality of incident prism portions and along an arrangement direction of the plurality of incident prism portions is referred to as a light guide direction, and
a width of each of the upper cover and the lower cover in the light guide direction is greater than a width of the back cover in the light guide direction.

9. The optical member according to claim 4, wherein
the light guide body has a terminal surface that connects the exit surface, the reflective surface, the upper surface and the lower surface, and
the holder further includes a rear cover that is disposed adjacent to the terminal surface of the light guide body and connects between the upper cover and the lower cover.

10. The optical member according to claim 9, wherein
a surface of the rear cover facing the light guide body is a light-shielding and rough surface.

11. The optical member according to claim 9, wherein
the rear cover is formed with a recess that faces and holds the terminal surface of the light guide body.

12. The optical member according to claim 9, wherein
each of the upper cover, the lower cover, and the rear cover has an exit-side surface that is adjacent to a surface facing the light guide body and located closer to the exit surface of the light guide body than the reflective surface, and
the exit-side surface of each of the upper cover, the lower cover and the rear cover has curved ends without edged corners.

13. The optical member according to claim 4, wherein
the light guide body has ribs that protrude from the reflective surface at positions adjacent to the upper surface and the lower surface of the light guide body.
